(19) United States
(12) Patent Application Publication
(10) Pub. No.: US 2024/0388225 A1
(43) Pub. Date: Nov. 21, 2024

(54) Energy conversion element and temperature regulator using the same

(71) Applicant: Kenji Katori, Yokohama-Shi (JP)

(72) Inventor: Kenji Katori, Yokohama-Shi (JP)

(21) Appl. No.: 18/260,243

(22) PCT Filed: Jan. 1, 2021
(86) PCT No.: PCT/JP2022/000002

§ 371 Date: Jul. 1, 2023

(30) Foreign Application Priority Data
Jan. 19, 2021 (JP) 2021-006491
Jun. 10, 2021 (JP) 2021-097168

(51) Int. Cl. H02N 99/00; H01F 1/01; H01F 7/02

(52) U.S. Cl. CPC H02N 99/00; H01F 1/012; H01F 7/02

(57) ABSTRACT

Generating temperature difference from kinetic energy using rotating magnetocaloric materials: Series connection of magnetocaloric materials expands the temperature difference region and produces a cooling system without vibration noise.

### TECHNICAL FIELD

The present disclosure relates to an energy conversion element structure and constituent materials for converting kinetic energy to temperature difference energy, and a temperature control device using the same.

### BACKGROUND ART

Vapor compression chillers, which produce low temperatures when a gaseous refrigerant is compressed and evaporated, are widely used in refrigerators and air conditioners. Another known method of vaporizing refrigerant is the absorption refrigerator, which uses the low pressure generated when a liquid with high absorption capacity absorbs another refrigerant. Furthermore, a Peltier element that directly generates temperature difference energy from electrical energy has also been developed and put into practical use.

Further, research and development have been conducted on a magnetic refrigerator using a magnetocaloric material that generates heat when a magnetic field is applied and absorbs heat when the magnetic field is removed. The magnetic refrigeration method that has been researched and developed so far is a method in which the magnetic calorific effect of a magnetic material is propagated by a heat exchange fluid and a predetermined refrigeration cycle is driven to obtain a refrigerating temperature range and a refrigerating capacity. This is generally called the AMR (Active Magnetic Regenerator) freezing method, and is recognized as an effective method for magnetic freezing near room temperature (Japanese Patent No. 5060602).

In Japanese Patent 6960492, the present inventor proposes an element that converts kinetic energy into temperature difference energy using a rotating magnetocaloric material.

### PRIOR ART DOCUMENT

### Patent Document

Patent Document 1: Japanese Patent No. 5060602
Patent Document 2: Japanese Patent No. 6960492

### Non-Patent Document

### [Non-Patent Document 1]

Magnetic refrigeration technology that realizes chlorofluorocarbon free-Toshiba Corporation, Toshiba Review Vol. 62, No. 9 (September 2007), https://www.toshiba.co.jp/tech/review/2007/09/62_09pdf/rd01.pdf

### SUMMARY OF THE INVENTION

### Problem to be Solved by the Invention

All of the above cooling methods are methods of converting electrical energy, kinetic energy, etc. into energy of temperature difference to generate a low temperature portion and a high temperature portion. The conversion from electrical energy to temperature difference energy can be simply converted by the Peltier element, but the conversion from kinetic energy to temperature difference energy requires a complicated structure. That is, gas compression, vaporization, or in the case of magnetic refrigeration, an AMR device that moves the refrigerant in synchronization with the application of a magnetic field accompanied by noise and vibration, are required. In the AMR device, a complicated mechanism accompanied by noise and vibration such as refrigerant adjustment synchronized with the application of a magnetic field is required.

The method developed by the inventor (Japanese patent 6960492) is a method of converting kinetic energy to temperature difference energy, directly converting the energy without complicated operations including opening and closing of valves, such as magnetic refrigeration AMR, and directly outputting temperature difference energy without noise and vibration by inputting kinetic energy to the element. The purpose of the present invention is to further develop this method.

### Solutions to Problems

In order to achieve the above object, the first disclosure is the structure of the energy conversion element which includes magnetocaloric materials having two different temperature regions connected in series so that the temperature of the low temperature state of one magnetocaloric material is thermally connected to the high temperature state of the other magnetocaloric material in the same magnetic field during operation, within the energy conversion element in which the space between the magnetocaloric material which rotates or reciprocates and the magnetic field application section which includes permanent magnets for applying a magnetic field to the magnetocaloric material are filled with a liquid or a liquid in which fine particles are dispersed or magnetic fluid and in which the output of the heat on the high temperature side is made through the magnetic field application part by thermal conduction of the heat generated by the application of the magnetic field by the permanent magnets.

The second disclosure is the structure of an energy conversion element characterized by a plurality of magnetocaloric materials with different temperature regions connected in series so that the temperature of the low temperature state of one magnetocaloric material is thermally connected to the high temperature state of the other magnetocaloric material during operation in the same disk or cylinder or cone, within the energy conversion element in which the space between the magnetocaloric material which rotates or reciprocates and the magnetic field application section which includes permanent magnets for applying a magnetic field to the magnetocaloric material are filled with a liquid or a liquid in which fine particles are dispersed or magnetic fluid and in which the output of the heat on the high temperature side is made through the magnetic field application part by thermal conduction of the heat generated by the application of the magnetic field by the permanent magnets.

The third disclosure is the structure of the energy conversion element of the second disclosure, in which a ferromagnetic material is used for the material constituting the rotating cylinder to make it part of the magnetic circuit with magnets applied to heat the magnetocaloric material.

The fourth disclosure is the structure of an energy conversion element characterized by a plurality of magnetocaloric materials having different temperature regions connected in series so that the temperature of the low temperature state of one magnetocaloricing material is thermally connected to the high temperature state of the other magnetocaloric material on both sides of a disk or cylinder or conical base whose surface is composed of a heat insulating material, within the energy conversion element in which the space between the magnetocaloric material which rotates or reciprocates and the magnetic field application section which includes permanent magnets for applying a magnetic field to the magnetocaloric material are filled with a liquid or a liquid in which fine particles are dispersed or magnetic fluid and in which the output of the heat on the high temperature side is made through the magnetic field application part by thermal conduction of the heat generated by the application of the magnetic field by the permanent magnets.

The fifth disclosure is the structure of the energy conversion element assembly characterized in that a plurality of energy conversion elements as in one of the disclosures 1-4 are connected in series by directly or thermally connecting the low-temperature portion and the high-temperature portion of a separate unit, respectively, and heat exchangers are also installed at the stacking joints of the elements, thereby increasing the temperature range of heating and cooling and enabling output in multiple temperature ranges.

The sixth disclosure is the configuration of the temperature control device that uses the multiple temperature range outputs of the energy conversion element assembly in the cooling or heating section to simultaneously regulate temperatures in multiple temperature ranges.

### Advantageous Effect of the Invention

According to the present disclosure, the operating temperature can be expanded more conveniently in a method that simply converts kinetic energy into temperature difference energy without noise and vibration and without opening and closing complicated valves. In addition, it is possible to obtain a heating or cooling device that can provide multiple temperature ranges more easily using the energy conversion element. The effects described here are not necessarily limited, and may be any of the effects described in the present disclosure or effects different from those described herein.

### BRIEF EXPLANATION OF THE DRAWINGS

FIG. 1 is a cross-sectional view of the structure of an energy conversion element for the first example embodiment of the present disclosure, in which the magnetocaloric materials are arranged on both sides with a low thermal conductivity material in the middle in the same applied magnetic field. The low temperature part of one magnetocaloric material is thermally connected to the high temperature part of the other magnetocaloric material via a heat transfer ring.

FIG. 2 is a top view without the heat collecting plate showing the configuration of an energy conversion element for the first example embodiment of the present disclosure, in which the magnetocaloric materials are arranged on both sides with a low thermal conductivity material in the middle in the same applied magnetic field, and multiple pairs of temperature difference output terminals are installed on the same magnetocaloric material. The temperature difference output terminals are thermally connected to the heat transfer ring.

FIG. 3 is a cross-sectional view of the structure of an energy conversion element characterized by a plurality of ring-shaped magnetocaloric materials with different temperature regions connected in series so that the temperature of the low temperature parts of magnetocaloric materials are thermally connected to the high temperature parts of the other magnetocaloric materials in the same disk of the second of the present disclosure. The low temperature parts of magnetocaloric materials are thermally connected to the high temperature parts of the other magnetocaloric materials via heat transfer rings.

FIG. 4 is a cross-sectional view of the structure of an energy conversion element characterized by a plurality of ring-shaped magnetocaloric materials with different temperature regions connected in series so that the temperature of the low temperature parts of magnetocaloric materials are thermally connected to the high temperature parts of the other magnetocaloric materials in the same disk of the second of the present disclosure. The low temperature parts of magnetocaloric materials are thermally connected to the high temperature parts of the other magnetocaloric materials via magnetic yokes.

FIG. 5 is a top view of the structure of an energy conversion element characterized by a plurality of ring-shaped magnetocaloric materials with different temperature regions connected in series such that the temperature of the low temperature parts of one magnetocaloric materials are thermally connected to the high temperature parts of the other magnetocaloric materials in the same disk of the second of the present disclosure. The low temperature parts of one magnetocaloric materials are thermally connected to the high temperature parts of the other magnetocaloric materials via magnetic yokes.

FIG. 6 is a cross-sectional view of an energy conversion element characterized by a plurality of ring-shaped magnetocaloric materials with different temperature regions connected in series so that the temperature of the low temperature parts of one magnetocaloric material is thermally connected to the high temperature parts of the other magnetocaloric material on both sides of a disk composed of heat insulation material in the 4th of the present disclosure.

FIG. 7 is a top view of an energy conversion element characterized by a plurality of ring-shaped magnetocaloric materials with different temperature regions connected in series so that the temperature of the low temperature parts of magnetocaloric materials are thermally connected to the high temperature parts of the other magnetocaloric materials on both sides of a disk composed of heat insulation material in the 4th of the present disclosure.

FIG. 8 is a cross-sectional view of a stacked element with heat exchangers also installed at the element stacking joints in which a number of ring-shaped magnetocaloric materials with different temperature regions are arranged in series connected so that the temperature of the low temperature parts of one magnetocaloric materials are thermally connected to the high temperature parts of the other magnetocaloric materials on both sides of disks composed of heat insulation materials in the 4th and 5th of the present disclosure.

FIG. 9 is a cross-sectional view of an energy conversion element using a rotating disk-shaped magnetocaloric material.

FIG. 10 is a cross-sectional view of the configuration of an energy conversion element for the first example embodiment of the present disclosure in which the magnetocaloric materials are arranged on both sides with a low thermal conductivity material in the middle in the same applied magnetic field. The low temperature part of one magnetocaloric material is thermally connected to the high temperature part of the other magnetocaloric material via a heat transfer ring.

FIG. 11 is a cross-sectional view of the structure of an energy conversion element characterized by a plurality of ring-shaped magnetocaloric materials with different temperature regions connected in series so that the low temperature parts of magnetocaloric materials are thermally connected to the high temperature parts of the other magnetocaloric materials in the same disk of the second of the present disclosure. The low temperature parts of magnetocaloric materials are thermally connected to the high temperature parts of the other magnetocaloric materials via magnetic yokes.

FIG. 12 is a cross-sectional view of an energy conversion element characterized by the use of a ferromagnetic material as the material comprising the rotating cylinder of the third of present disclosure, which is part of a magnetic circuit with magnets applied to heat the magnetocaloric material. The left side of the broken line is the cross section when the low temperature output is installed in the top and bottom stages, and the right side of the broken line is the cross section when the high temperature output is installed in the top and bottom stages.

FIG. 13 is a cross-sectional view of the top surface permanent magnet portion of an energy conversion element characterized by the use of a ferromagnetic material as the material comprising the rotating cylinder of the third of present disclosure, which is part of a magnetic circuit with magnets applied to heat the magnetocaloric material.

FIG. 14 is a cross-sectional view of an energy conversion element stacked assembly characterized by the use of a ferromagnetic material as the material comprising the rotating cylinders of the third and fifth of present disclosure, which is part of a magnetic circuit with magnets applied to heat the magnetocaloric material. The left side of the broken line is the cross section when the low temperature output is installed in the top and bottom stages, and the right side of the broken line is the cross section when the high temperature output is installed in the top and bottom stages.

### MODE FOR CARRYING OUT THE INVENTION

Embodiments of the present are will be described in the following order.

| | |
|---|---|
| 1 | 1st embodiment |
| 2 | 2nd embodiment |
| 3 | 3rd embodiment |
| 4 | 4th embodiment |
| 5 | 5th embodiment |
| 6 | 6th embodiment |

### 1 1st Embodiment

### (Magnetocaloric Material)

In the AMR device, which has been conventionally researched and developed as a magnetic refrigeration technique, particulate magnetocaloric materials are used to reciprocate a refrigerant in this gap, but in the present disclosure, disk-shaped, cylindrical or conical magnetocaloric materials attached to a rotating shaft are used. A high-temperature output terminal with a strong magnetic field that generates heat in the magnetocaloric material and a low-temperature output terminal with no magnetic field or a weak magnetic field that does not generate heat in the magnetocaloric material are installed to sandwich the magnetocaloric material rotated by the rotating shaft.

Gd (gadolinium)-based alloys, Mn (manganese)-based alloys, La (lanthanum)-based alloys, boron compounds, etc. can be used as magnetocaloric materials.

### (High Temperature Output Terminal)

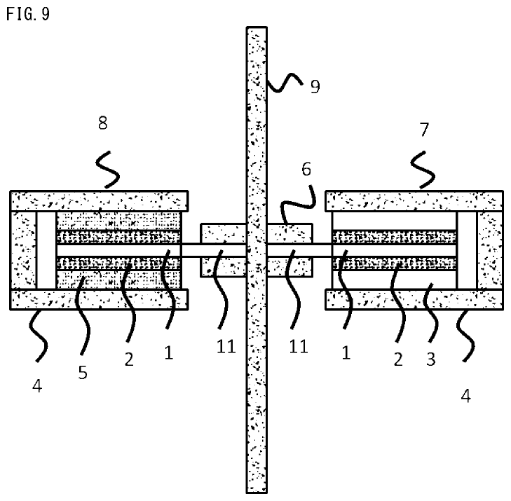

A magnetic field is applied by installing a magnetic field application section containing permanent magnets in a manner that sandwiches the rotating magnetocaloric material, which are necessary to heat the magnetocaloric material that are mounted on a rotating shaft. Liquids or liquids in which fine particles are dispersed are introduced between the magnetocaloric material and the magnetic field application part. Magnetic fluids can be used as the liquid or the liquid in which the fine particles are dispersed. Even when the magnetocaloric material rotates, the magnetic fluid is attracted to the magnetic field and stays in the magnetic field application part. Here, when the magnetic field is applied, the magnetization directions of the magnetocaloric material are aligned, so that the magnetocaloric material generates heat. This heat generation is heat-conducted to the magnetic field application section through the liquid or the liquid in which the fine particles are dispersed, and the magnetic field application section itself becomes the high temperature output terminal, and the high temperature heat quantity can be taken out from the magnetic field application section (FIG. 9).

### (Low Temperature Output Terminal)

The magnetocaloric material emitted from a strong magnetic field is cooled because the direction of magnetization becomes random. A low temperature output terminal is installed to transfer low temperature to the outside in the low temperature state at this time. The low-temperature output terminal does not apply a magnetic field or has a weak magnetic field that does not heat the magnetocaloric material between the gap sandwiching the magnetocaloric material. The magnetocaloric material and the low temperature output terminal are thermally conducted by a liquid or a liquid in which fine particles are dispersed (FIG. 9). Permanent magnets are installed so that the magnetic field is weak at about 0. 03T by sandwiching a rotating disk-shaped magnetocaloric material mounted on a rotating shaft. Magnetic fluids are introduced between the magnetocaloric material and the weak magnet. Even when the magnetocaloric material rotates, the magnetic fluids are attracted to the magnetic field and stay in the magnet part. The magnetite magnetic powder used in the magnetic fluid is strongly attracted to the magnet even if it is about 0.03 T, and stays in the magnet part even when the magnetocaloric material rotates. On the other hand, in a magnetic field of about 0.03 T, the magnetization directions of the magnetocaloric material are not sufficiently aligned, and the magnetocaloric material does not generate sufficient heat and is maintained in a low temperature state. This low temperature is conducted to the magnet through the magnetic fluids, and the magnet portion itself becomes a low temperature output terminal, and other materials can be cooled through the magnet portion.

The magnetic fluids filled in the high-temperature output terminal and the low-temperature output terminal can be attracted by the respective magnets and can maintain the high-temperature state and the low-temperature state, respectively, without mixing with each other (FIG. 9). By installing a low thermal conductive material between the high temperature output terminal and the low temperature output terminal, it is possible to prevent the magnetic fluids from crossing each other more positively.

Although the example of rotation of the magnetocaloric material has been shown so far, it may be a reciprocating motion between the high temperature output terminal and the low temperature output terminal.

### (Multiple Paired Thermal Output Terminals)

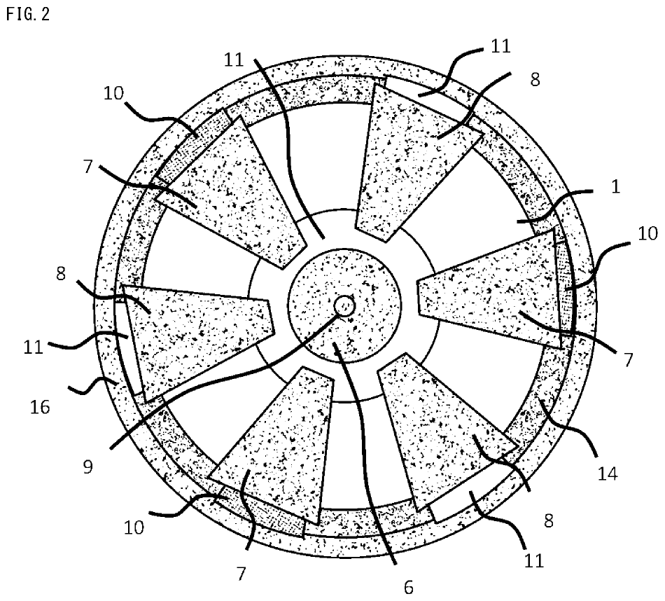

Multiple pairs of temperature difference output terminals can be installed on the same magnetocaloric material (FIGS. 2, 5, 7, 13). By installing multiple pairs of temperature difference output terminals on the same magnetocaloric material, the magnetocaloric material will repeat high and low magnetic fields with fewer rotations, which will increase the amount of temperature difference heat generated per rotation of the magnetocaloric material.

The low and high temperature output terminals can be fan-shaped, arc-shaped, or cylindrical, respectively, following the shape of the magnetocaloric material.

### (Magnetocaloric Materials in Two Different Temperature Ranges in the Same Magnetic Field)

In order to increase the temperature difference, the aforementioned elements are stacked. In order to obtain a wide range of temperature difference, it is necessary to increase the number of stacking stages. However, since a magnetic field application device is required for each magnetocaloric material, the number of required magnetic field application devices also becomes larger when the temperature difference is expanded.

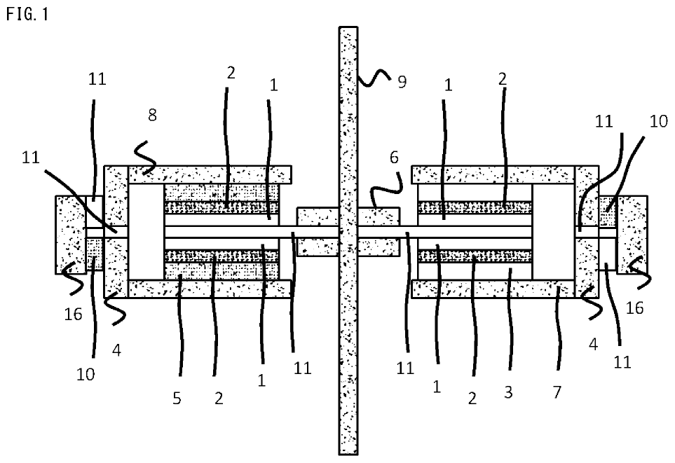

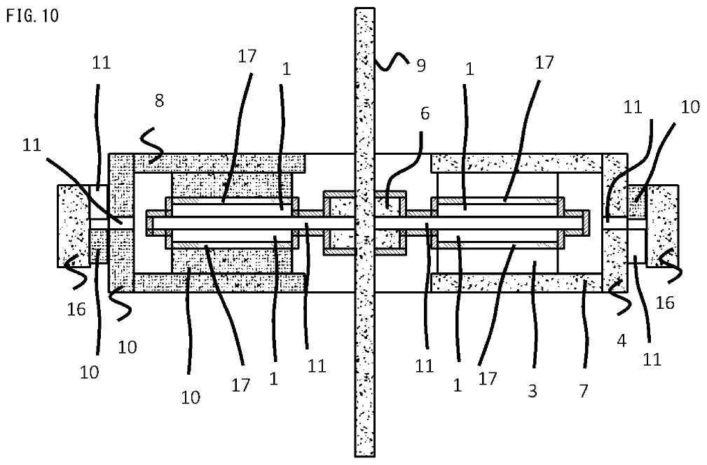

By placing a disk with a structure in which magnetocaloric materials are arranged on both sides with a low thermal conductivity material in the middle in the same magnetic field, and by placing a low thermal conductivity material between the N-and S-pole terminals at the high and low temperature heat output terminals to which the magnetic field is applied, magnetocaloric materials of independent temperatures can be arranged in the same magnetic field. This makes it possible to generate a temperature difference equivalent to two layers of stacking in a single applied magnetic field (FIGS. 1, 10). Here, a heat transfer ring is placed around the perimeter to make a series connection of the temperature difference generated in each magnetocaloric material. By having the cold part of one magnetocaloric material and the hot part of the other magnetocaloric material at the same temperature through the heat transfer ring, the resulting temperature difference can be approximately doubled for a set of applied magnetic fields.

### 2 2nd Embodiment

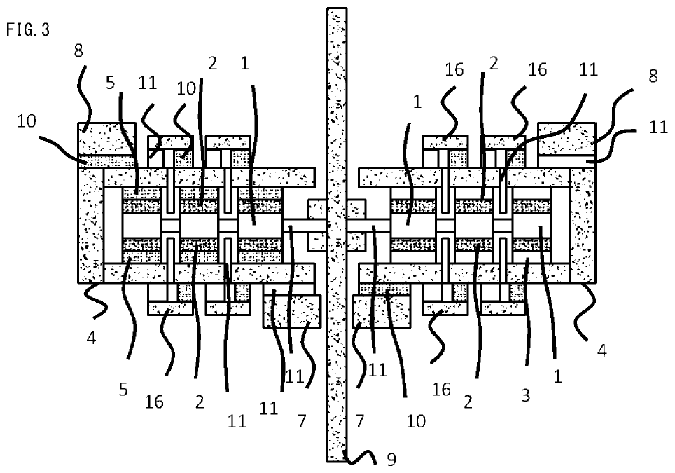

In the previous section, we aimed to expand the operating temperature by distributing the magnetocaloric material on both sides of the disk-type heat insulation material, but the operating temperature can be also expanded by dividing the magnetocaloric material into rings in the plane of the disk (FIG. 3). The disk-shaped magnetocaloric material is divided into ring shapes with heat insulations sandwiched in between. The magnetic yoke is also insulated to allow independent temperature operation within the same disk surface. Furthermore, by thermally connecting the low temperature state of one magnetocaloric material with the high temperature state of the other magnetocaloric material via a heat transfer ring, the operating temperature can be extended with in the same disc surface. An example of three divisions is shown here, but the number of divisions can be adjusted as needed. Although the relative velocity of the inner magnetocaloric material ring is slower than that of the outer ring, the amount of heat generated can be equalized by adjusting the ring width.

Although a disk-shaped example is shown here, a conical or cylindrical shape can be used instead of a disk.

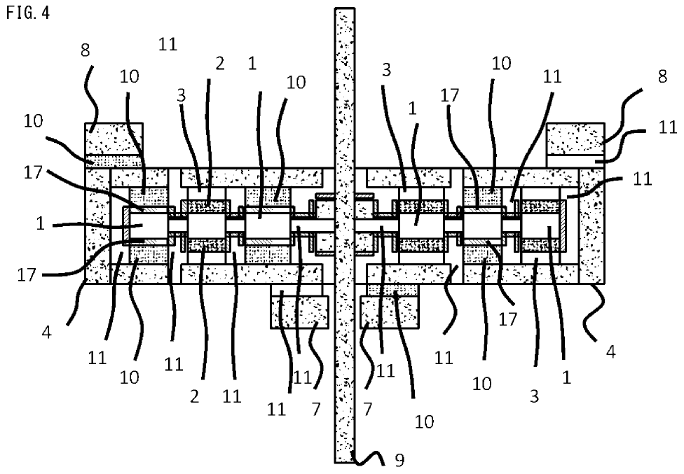

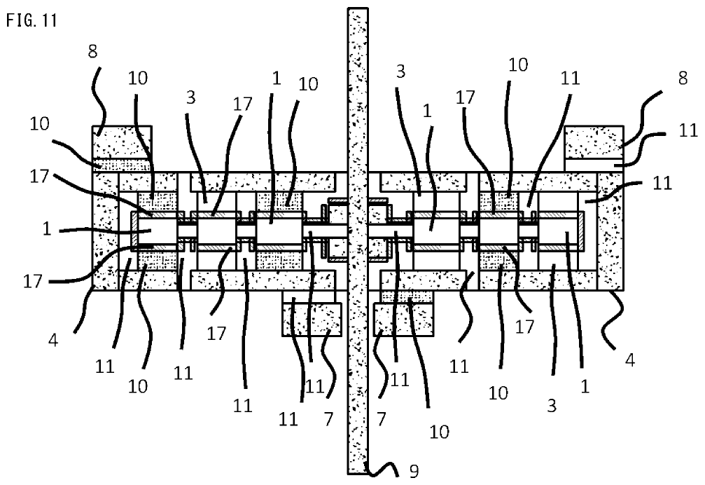

In the above example of temperature expansion, a method using a heat transfer ring was described for thermal bonding of different magnetocaloric materials. Even without a heat transfer ring, it is possible to thermally bond magnetocaloric materials by adjusting the applied magnetic field in the same magnetic yoke (FIGS. 4 and 11). Here, in the same magnetic yoke, there are two locations: one where the applying magnet is installed and one where it is not installed. In the area where the applying magnet is installed, the magnetocaloric material generates heat, resulting in a high-temperature output terminal, while in the area where the applying magnet is not installed, the magnetocaloric material does not generate heat, resulting in a low-temperature output terminal. By alternating the locations where these applied magnets are installed and where they are not installed, and by appropriately placing heat insulation in the magnetic yoke, it is possible to thermally connect the low temperature state of one magnetocaloric material to the high temperature state of the other. In FIG. 4, the low temperature output of the inner magnetocaloric material is thermally connected to the high temperature output of the middle magnetocaloric material through the magnetic yoke, and the low temperature output of the middle magnetocaloric material is thermally connected to the high temperature output of the outer magnetocaloric material through the magnetic yoke. In this way, it is possible to expand the temperature difference by three steps in the same disk. In this method, the high temperature output terminal is placed close to the low temperature output terminal, and if magnetic fluid is placed for thermal connection, the magnetic fluid may be attracted by the stronger magnetic field, so the low temperature output terminal can be thermally connected with liquid or liquid with dispersed fine particles instead of magnetic fluid.

### 3 3rd Embodiment

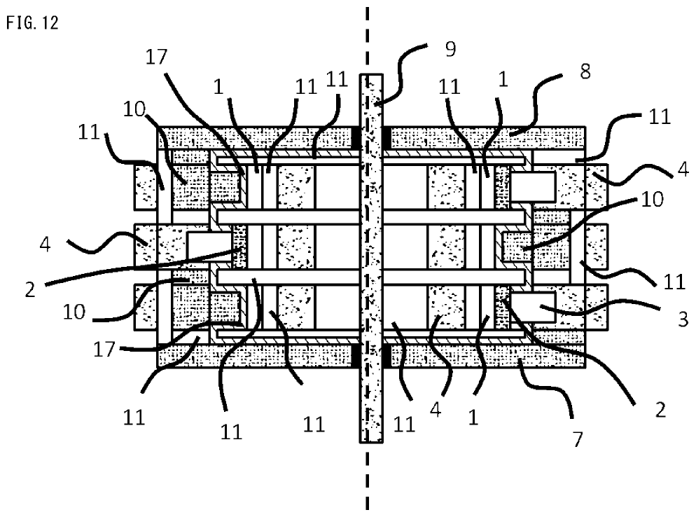

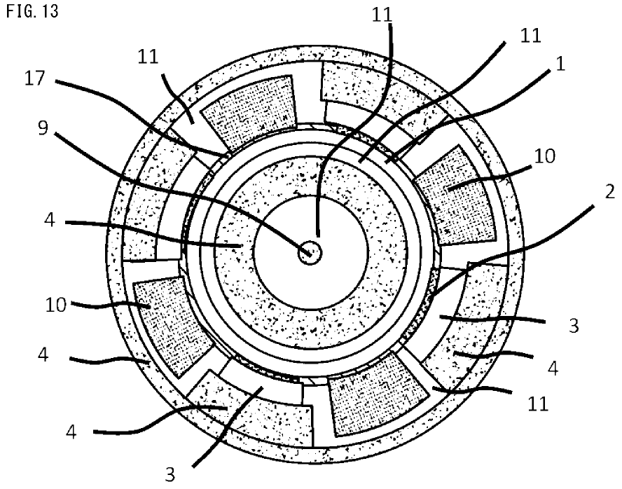

In the second embodiment above, we have shown an example of a disk shape. Since there is an attractive force between the magnetocaloric material and the magnet for applying the magnetic field, it is necessary to ensure the strength of the disk. Here, we show an example of a cylindrical shape that can ensure more mechanical strength. Rings of magnetocaloric materials are placed around a cylindrical heat insulator, and permanent magnets are applied from around the rings to generate heat in the magnetocaloric materials (FIGS. 12 and 13). The outer circumference of the cylinder, where the magnetocaloric materials come in contact with them, should be heat insulated to retain the heat generated by the heated magnetocaloric materials. On the other hand, in order to efficiently apply the magnetic field, yokes must be installed, and these yokes can be installed in a rotating cylinder. By installing ferromagnetic materials, preferably iron-based materials, inside the cylinder heat insulation, the rotating cylinder simultaneously becomes part of the magnetic circuit and reduces magnetic resistance. The high and low temperature output terminals, which include magnetic field application devices, are placed alternately around the cylinder. By changing the polarity of the applied magnetic field between the high temperature output terminals and the neighboring high temperature output terminals via the low temperature output terminals, instead of the same N-S direction between the high temperature output terminals, efficient magnetic circuits can be constructed, including the magnetic yokes installed in the rotating cylinder.

### 4 4th Embodiment

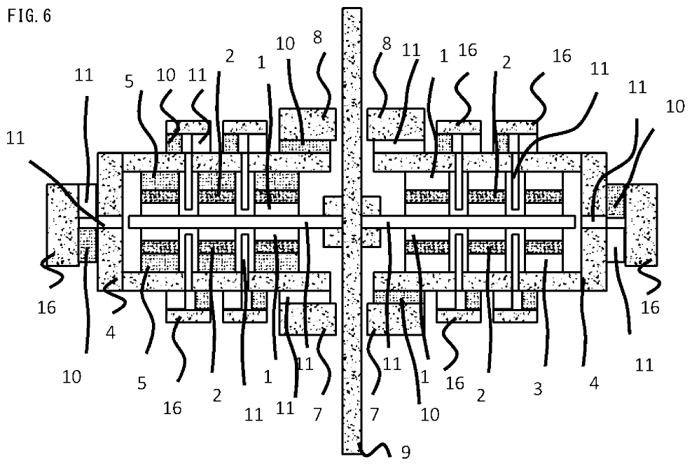

Further expansion of the operating temperature can be achieved by combining 1st and 2nd above. The operating temperature can be further extended by placing several ring-shaped magnetocaloric materials on both sides of a disk made of heat insulating material and connecting these magnetocaloric materials thermally in series (FIG. 6). These methods can be optimized according to the required characteristics such as temperature difference, heat capacity, weight, and volume of the required cooling system, etc. In this case, the magnetocaloric material used in each element does not have to be the same. Magnetocaloric materials with different optimum operating temperatures can be arranged according to the operating temperature in each element to further increase the temperature difference.

An attractive force is generated between the magnetocaloric material and the applied magnet. To increase the strength of the disk, the disk can be made of metal and its surface can be thermally insulated.

Here we have shown an example of a disk shape, but instead of a disk shape, a cone shape or a cylindrical shape can be used.

### 5 5th Embodiment

### (Stacked)

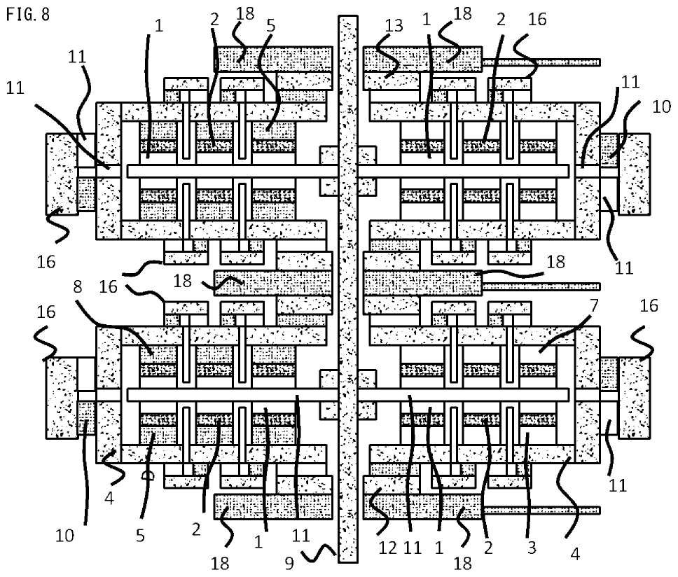

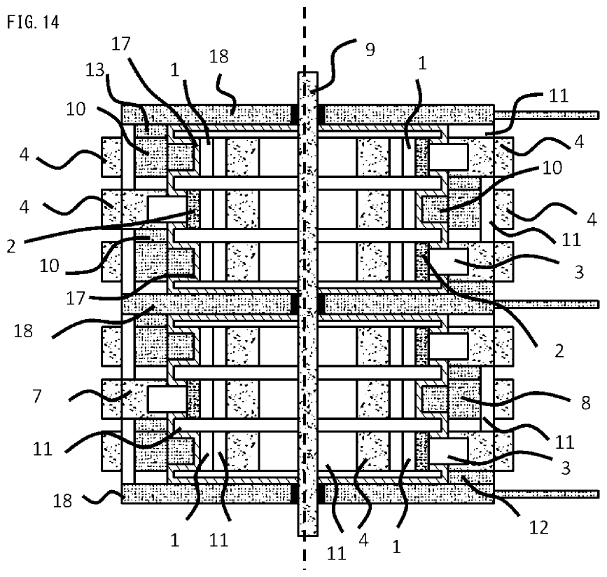

By connecting the energy conversion elements in series, the temperature difference can be expanded. By connecting the low-temperature output terminal and the high-temperature output terminal of separate elements with good thermal conductivity, the low-temperature output terminal and the high-temperature output terminal become the same temperature. As a result, the temperature difference between the output terminals on the unconnected side increases further (FIGS. 8 and 14). Here, an example of a two-stage connection is shown, but the number of stacks can be increased in the same way if necessary to obtain the desired temperature difference. In this case, the magnetocaloric material used for each stacked element does not have to be the same. Magnetocaloric materials with different optimum operating temperatures can be arranged according to the operating temperature of each element to further increase the temperature difference.

### (Multiple Temperature Range Outputs)

When stacking elements, heat exchangers can also be installed at the junctions (FIGS. 8, 14). This allows for multiple temperature outputs. By adjusting the amount of heat medium introduced to the heat exchangers in each temperature range, the output heat amount in each temperature region can be adjusted independently.

### 6 6th Embodiment

In case elements are connected in series in the same magnetic field and in the same disk with a temperature difference, and these elements are connected in series to widen the operating temperature difference, they can be used for applications such as air conditioners and refrigerators. Since rotational kinetic energy can be directly converted into temperature difference energy and there is little conversion energy loss, it can be used for cooling and heating of electric vehicles, which require less energy loss. In addition, as described in section 5 above, heat output in multiple temperature ranges can be easily achieved from the combined parts of the stacked elements, so multiple heat output temperature control devices such as cooling and heating, freezing and refrigeration, etc. are easily possible. Because of its low noise level, it can also be used in hotel room refrigerators and freezer S.

### EXAMPLES

Hereinafter, the present disclosure will be specifically described with reference to Examples, but the present disclosure is not limited to these Examples.

This embodiment will be described in the following order.
i Composite elements in the same magnetic field
ii Same disk composite element
iii Same cylinder composite element
iv Heat insulation disk double-sided composite element
v Multiple heat exchanger installation stacked elements
vi Multiple temperature control temperature regulator

### i Example of a Composite Element in the Same Magnetic Field

### Example 1

A stainless steel shaft 5 mm in diameter and 50 mm in length was prepared.

Magnetocaloric materials Gd (gadolinium) with a thickness of 0.8 mm were adhered to a 20-mm upper and lower peripheral portion of a disk-shaped polycarbonate with a thickness of 1.5 mm and a diameter of 40 mm. The center of this disk was fixed to the stainless steel shaft described above. Rotation of the shaft causes the magnetocaloric materials to rotate.

To apply a magnetic field to the magnetocaloric materials, permanent magnets with a yoke was installed to sandwich the disk-shaped magnetocaloric materials. NdFeB magnets were used as permanent magnets with a gap spacing of 5.5 mm. The magnetic flux in the gaps was 0.9 T. In order to maintain independent temperatures at the upper and lower interior of the yoke, thermal insulation was placed in the middle of the yoke. Magnetic fluids consisting of magnetite magnetic powder were filled between the magnetocaloric material and the permanent magnet to create a high-temperature output terminal (FIG. 1).

In order to install the low temperature output terminal on the opposite side of the circumference of the high temperature output terminal, permanent magnets with a yoke were installed to sandwich the disk-shaped magnetocaloric material. Sr-Ferrite magnets were used as the permanent magnets, and the gap spacing was 5.5 mm. The magnetic flux between the gaps was set to 0. 03 T. In order to maintain independent temperatures at the upper and lower interior of the yoke, thermal insulation material was placed in the middle of the yoke. Magnetic fluids consisting of magnetite magnetic powder were filled between the magnetocaloric material and the permanent magnet to make a low-temperature output terminal (FIG. 1).

A heat-transfer ring was installed around the periphery to make a series connection between the temperature differences generated in each of the upper and lower magnetocaloric materials. The low temperature part of one magnetocaloric material and the high temperature part of the other magnetocaloric material are thermally connected through the heat transfer ring and become close in temperature.

The room temperature and the initial temperature of the device were set at 23.0° C. The shaft was rotated at 5 rpm, and the temperatures of the high and low temperature output terminals at both ends of the energy conversion device were measured after 5 minutes. Here, the temperatures of the high and low temperature output terminals at both ends were 24.8° C. and 21.2° C., respectively. A temperature difference equivalent to two steps can be obtained with a pair of applied magnetic fields.

### Comparative Example 1

A stainless steel shaft with a diameter of 5 mm and a length of 50 mm was prepared.

The center portion of the disk with a diameter of 20 mm replaced from Gd (gadolinium) to polycarbonate was fixed to the aforementioned stainless steel shaft. Rotation of the shaft causes the disk-shaped magnetocaloric material to rotate. The thermal conductivity of Gd (gadolinium) is about 10.6 W/mK (300 K), while that of polycarbonate is much lower, about 0.19 W/mK (300 K). The heat conduction in the area that does not pass through the magnetic field was reduced (FIG. 9).

In order to apply a magnetic field to the magnetocaloric material, permanent magnets with a yoke was installed to sandwich the disk-shaped magnetocaloric material. The permanent magnets are NdFeB magnets with a gap spacing of 4.0 mm. The magnetic flux between the gaps was set to 0.9 T. Magnetic fluids consisting of magnetite magnetic powder were filled between the magnetocaloric material and the permanent magnet to form a high temperature output terminal.

In order to install the low temperature output terminal on the opposite side of the circumference of the high temperature output terminal, permanent magnets with a yoke were installed to sandwich the disk-shaped magnetocaloric material. Sr-Ferrite magnets were used as the permanent magnets, and the gap spacing was 4.0 mm. The magnetic flux between the gaps was set to 0.03 T. Magnetic fluids consisting of magnetite magnetic powder were filled between the magnetocaloric material and the permanent magnet to form a low-temperature output terminal (FIG. 9).

The room temperature and all the device constituent materials were initially set at 23.0° C. Rotation of the shaft rotated the disk-shaped magnetocaloric material fixed to the shaft. The rotation speed was set at 5 rpm. It was confirmed that the magnetic fluids were fixed by the high temperature output terminal and the low temperature output terminal, respectively, and did not move by the rotation of the magnetocaloric material. When the temperature was measured 3 minutes after the rotation of the shaft started, it was observed to be 24.0° C. for the high temperature output terminal and 22.0° C. for the low temperature output terminal.

### ii Same Disk Composite Element

### Example 2

A stainless steel shaft with a diameter of 5 mm and a length of 50 mm was prepared.

Ring-shaped magnetocaloric materials Gd (gadolinium) with thickness of 1.5 mm and a ring-shaped insulation material with a thickness of 1.0 mm were combined to form a disk (FIG. 6). Each magnetocaloric material operates in its own independent temperature range. The center of the disk is fixed to the stainless steel shaft described above. Rotation of the shaft rotates the magnetocaloric materials.

In order to apply magnetic fields to the magnetocaloric materials, several permanent magnets with yokes were installed to sandwich the disk-shaped magnetocaloric materials. NdFeB magnets were used as permanent magnets with a gap spacing of 4.0 mm. The magnetic flux between the gaps was set to 0.9 T. In order for multiple independent temperatures to be maintained in the yoke, heat insulations were installed in the yoke. Magnetic fluids consisting of magnetite magnetic powder were filled between the magnetocaloric material and the permanent magnet to form the high temperature output terminal (FIG. 3). Three high temperature output terminals were installed at equal intervals on the same disk.

To install the low-temperature output terminals on the opposite side of the circumference of the high-temperature output terminals, permanent magnets with yokes were installed to sandwich the disk. Multiple Sr-Ferrite magnets were used as permanent magnets with gap spacing of 4.0 mm. The magnetic flux between the gaps was set to 0. 03 T. Heat insulations were placed in the middle of the yokes in order to maintain independent temperatures within the yokes. Magnetic fluids consisting of magnetite magnetic powder were filled between the magnetocaloric materials and the permanent magnets to form low-temperature output terminals (FIG. 3). The low-temperature output terminals were installed in the same manner as the high-temperature output terminals, with three locations on the same disc, making it a multiple input/output terminals.

Heat transfer rings were placed on the top and bottom of the disk in order to make series connections between the temperature differences generated in each magnetocaloric material in the disk. The low temperature part of one magnetocaloric material and the high temperature part of the other magnetocaloric material are thermally connected through the heat transfer rings and become close in temperature. One transfer ring thermally connects three high temperature output terminals and three low temperature output terminals.

The room temperature and the initial temperature of the element were set to 23.0° C. The shaft was rotated at 5 rpm, and the temperatures of the high and low temperature output terminals at both ends of the energy conversion element were measured after 5 minutes. Here, the temperatures of the high and low temperature output terminals at both ends were 25.7° C. and 20.3° C., respectively. A temperature difference close to the equivalent of three stages can be obtained with a single element.

### Example 3

Magnetocaloric material and heat insulation composite disks similar to those in Example 2 were prepared and fixed to the same shaft as in Example 2. In order to apply magnetic fields to the magnetocaloric materials, multiple permanent magnets with yokes were installed so as to sandwich the ring-shaped magnetocaloric materials. The NeFeB permanent magnets were alternately placed between the magnetic yokes and the magnetocaloric materials, with and without the NeFeB permanent magnets, as high-temperature and low-temperature output terminals, respectively. Heat insulating resin was introduced into the air gap. Heat conduction by liquid was used between the low temperature output terminal and the ring-shaped magnetic working material. Magnetic fluids were introduced between the high-temperature output terminal and the ring-shaped magnetocaloric material to serve as a heat conductor. When the magnetocaloric material rotates, the magnetic fluids stay on the NeFeB-based permanent magnet and are not diffused.

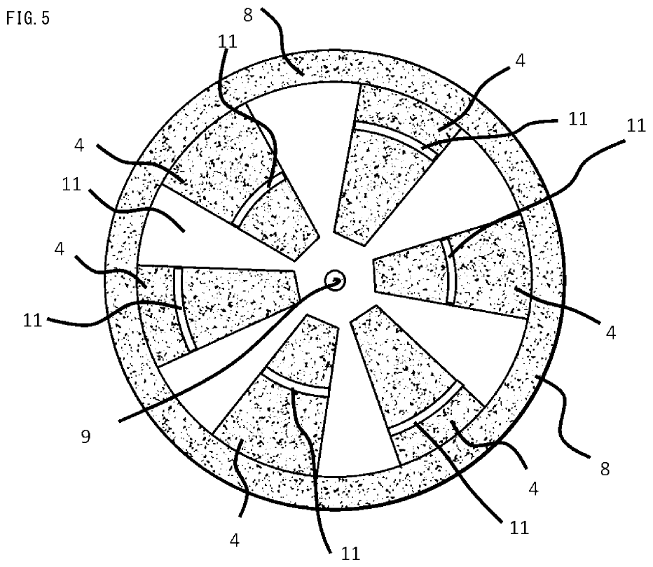

A thermal series connection was made through the magnetic yoke so that the temperature of the low temperature state of one magnetocaloric material was thermally connected to the high temperature state of the other magnetocaloric material by the heat insulation material placed in the magnetic yoke. The low and high temperature output terminals were installed in three locations on the same disk to form multiple in put/output terminals (FIGS. 4 and 5).

The room temperature and initial temperature of the element were set to 23.0° C. The shaft was rotated at 5 rpm, and the temperatures of the high and low temperature output terminals at both ends of the energy conversion element were measured after 5 minutes. The temperatures of the high and low temperature output terminals at both ends were 25.5° C. and 20.5° C., respectively.

The above is an example of using a magnetic fluid for heat conduction, but it is also possible to conduct heat from the magnetocaloric material to the heat output terminal using a liquid with high thermal conductivity (FIG. 11).

### iii Same Cylinder Composite Element

### Example 4

A stainless steel shaft 5 mm in diameter and 50 mm long was prepared. A cylindrical polycarbonate of 8 mm height and 20 mm diameter was placed around the shaft, and a ring-shaped iron magnetic yoke material was placed around it, followed by a ring-shaped polycarbonate and magnetocaloric material Gd (gadolinium). These cylinders were fixed to a stainless steel shaft as three layers via polycarbonate disks. When the shaft rotates, the cylinders also rotate (FIGS. 12 and 13).

To apply magnetic field to the ring-shaped magnetocaloric material, several permanent magnets with yokes were installed to sandwich the ring-shaped magnetocaloric materials. NeFeB permanent magnets were installed between the magnetic yokes and the magnetocaloric materials to serve as high-temperature output terminals. The sections with and without permanent magnets were arranged alternately as high-temperature output terminals and low-temperature output terminals, respectively. Heat insulating resins were introduced into the air gaps. Magnetic fluids were introduced between the high-temperature output terminals and the magnetocaloric materials. The magnetic fluids stay between the high-temperature output terminals and the magnetocaloric materials due to the force of the magnetic field even when the cylinder containing the magnetocaloric materials rotates, and conduct the heat generated by the applied magnetic field to the high-temperature output terminals. Between the low-temperature output terminal and the ring-shaped magnetocaloric material, heat is conducted by the liquid.

Ferrous magnetic yokes were introduced inside the cylinder. Through the cylinder, magnetic circuits were formed together with high-temperature output terminals with different magnetic polarities through the magnetic yoke materials further installed on the outer circumference. Compared to the case where no iron-based magnetic yoke is introduced inside the cylinder, it was found that only 20% less weight of NeFeB-based permanent magnet is needed to apply a magnetic field of 0.9 T when an iron-based magnetic yoke is introduced inside the cylinder.

In the same way as in Example 3, the heat insulating material and the heat transfer material are placed together to form a thermal series connection at the top and bottom so that the temperature of the low temperature state of one magnetocaloric material is thermally connected to the high temperature state of the other magnetocaloric material. The high temperature output terminal in the middle row of FIG. 21 is thermally connected to the low temperature output terminal in the lower row through a heat transfer material, and the low-temperature output terminal in the middle row is thermally connected to the high-temperature output terminal in the upper row. In this way, a series connection can be made thermally on the same cylinder.

The room temperature and the initial temperature of the device were set at 23.0° C. The shaft was rotated at 5 rpm, and the temperatures of the high and low temperature output terminals at both ends of the energy conversion device were measured after 5 minutes. The temperatures of the high and low temperature output terminals at both ends were 25.5° C. and 20.5° C., respectively.

### iv Heat Insulation Disk Double-Sided Composite Element

### Example 5

A stainless steel shaft with a diameter of 5 mm and a length of 50 mm was prepared.

A disc-shaped polycarbonate 1.5 mm thick, and six rings of Gd (gadolinium) 0.8 mm thick were glued to the upper and lower portions, three rings on each side independently. The center of the disk was fixed to the stainless steel shaft described above. Rotation of the shaft rotates the magnetocaloric materials.

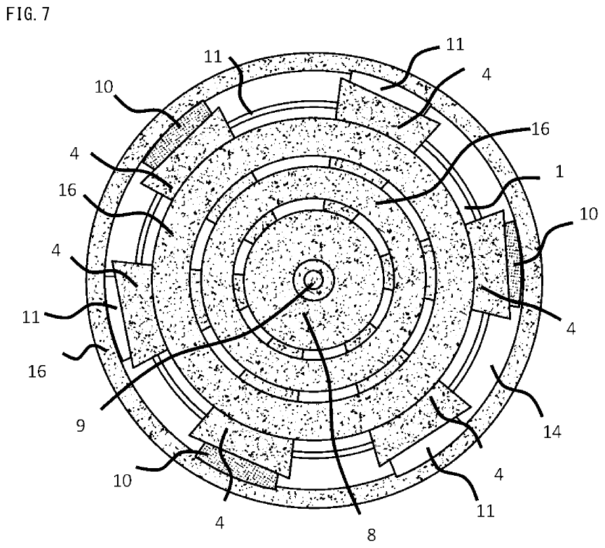

In order to apply magnetic field to the magnetocaloric materials, permanent magnets with yokes were installed to sandwich the disk-shaped magnetocaloric materials. The permanent magnets were NdFeB magnets with a gap of 5.5 mm. The magnetic flux in the gap was set to 0.9 T. In order to maintain independent temperatures at the upper and lower interior of the yoke, heat insulation was placed in the middle of the yoke. Magnetic fluids consisting of magnetite magnetic powder were filled between the magnetocaloric material and the permanent magnet to form the high temperature output terminals (FIGS. 6 and 7). Three high temperature output terminals were installed at equal intervals on the same disk.

To install the low temperature output terminal on the opposite side of the circumference of the high temperature output terminal, permanent magnets with yokes were installed to sandwich the disk. For the permanent magnets, multiple Sr-Ferrite magnets were used and the gap spacing was 5.5 mm. The magnetic flux in the gaps was set to 0.03 T. In order to maintain an independent temperature in the yoke, heat insulations were installed in the yoke. Magnetic fluids made of magnetite were filled between the magnetocaloric material and the permanent magnet to form the low temperature output terminal (FIGS. 6 and 7). The low-temperature output terminals were installed in three locations on the same disk as the high-temperature output terminals, making multiple input/output terminals.

Heat transfer rings were placed above and below the disks to make a series connection between the temperature differences generated by each magnetocaloric material in the disks. The low temperature part of one magnetocaloric material and the high temperature part of the other magnetocaloric material are thermally connected through the heat transfer ring and become close in temperature. One connection ring thermally connects three high temperature output terminals at each of the top and bottom, and three low temperature output terminals at each of the top and bottom. A heat transfer ring was installed around the periphery to make a series connection between the temperature differences generated in each of the upper and lower magnetocaloric materials. The low temperature part of one magnetocaloric material and the high temperature part of the other magnetocaloric material are thermally connected through the heat transfer ring, and the temperatures are close together.

The room temperature and the initial temperature of the device were set at 23.0° C. The shaft was rotated at 5 rpm, and the temperatures of the high and low temperature output terminals at both ends of the energy conversion device were measured after 5 minutes. The temperatures of the high and low temperature output terminals at both ends were 27.8° C. and 18.2° C., respectively. A temperature difference equivalent to six steps can be obtained with a single element.

### v Multiple Heat Exchanger Installation Stacked Elements

### Example 6

In the energy conversion devices shown so far, the temperature difference generated can be increased by thermally connecting the high temperature part of one element and the low temperature part of another element in a series connection. By installing a heat exchanger in the low and high temperature parts of the stacked elements, it is easy to produce an intermediate temperature (FIGS. 8 and 14).

The temperature difference range was expanded by stacking the insulated disk double-sided composite elements shown in Example 5. In this case, heat exchangers were installed not only in the low and high temperature output sections, but also in the joint section. In this way, multiple heat outputs can be obtained (FIG. 8).

Although examples of using Gd (gadolinium) as magnetocaloric materials are shown here, other magnetocaloric materials can be employed depending on the temperature range required, and the composition of the magnetocaloric material can be changed in the stacking and in the element to use magnetocaloric materials suitable for that temperature.

### vi Multiple Temperature Control Temperature Regulator

### Example 7

A temperature control device having multiple temperature outputs is obtained using the multi-heat exchanger stacked element. Using the energy conversion element assembly shown in FIG. 8, the heat exchanger connected to the high temperature output terminal was set to 23° C. with cooling water. The shaft was rotated at 5 rpm, and the temperature of the low temperature output terminal of the energy conversion element stacked assembly was measured after 10 minutes. Here, the heat out put from the middle heat exchanger was 13.6° C., and the heat output from the heat exchanger connected to the low temperature output terminal was 4.4° C. A device capable of cooling at multiple temperatures with only one stacked element was obtained. Although the example shown here is a cooling system, it is possible to build a heating system that can output multiple temperature, or a system that can simultaneously cool and heat.

### DESCRIPTION OF REFERENCE SYMBOLS

1: Magnetocaloric material
2: Magnetic fluid
3: NdFeB permanent magnet
4: Iron-based magnetic yoke material
5: Sr-Ferrite permanent magnet
6: Hub for installing magnetocaloric material
7: High temperature output terminal
8: Low temperature output terminal
9: Axis of rotation
10: Heat conductive material
11: Heat insulating material
12: Stacked high temperature output terminal
13: Stacked low temperature output terminal
14: High temperature side heat collector plate
15: Low temperature side heat collector plate
16: Heat transfer ring
17: Heat transfer liquid
18: Heat exchanger

1. An energy conversion element which includes magnetocaloric materials having two different temperature regions connected in series so that the temperature of the low temperature state of one magnetocaloric material is thermally connected to the high temperature state of the other magnetocaloric material in the same magnetic field during operation, within the energy conversion element in which the space between the magnetocaloric material which rotates or reciprocates and the magnetic field application section which includes permanent magnets for applying a magnetic field to the magnetocaloric material are filled with a liquid or a liquid in which fine particles are dispersed or magnetic fluid and in which the output of the heat on the high temperature side is made through the magnetic field application part by thermal conduction of the heat generated by the application of the magnetic field by the permanent magnets.

2. An energy conversion element characterized by a plurality of magnetocaloric materials with different temperature regions connected in series so that the temperature of the low temperature state of one magnetocaloric material is thermally connected to the high temperature state of the other magnetocaloric material during operation in the same disk or cylinder or cone, within the energy conversion element in which the space between the magnetocaloric material which rotates or reciprocates, and the magnetic field application section which includes permanent magnet for applying a magnetic field to the magnetocaloric material are filled with a liquid or a liquid in which fine particles are dispersed or magnetic fluid and in which the output of the heat on the high temperature side is made through the magnetic field application part by thermal conduction of the heat generated by the application of the magnetic field by the permanent magnets.

3. An energy conversion element according to claim 2, in which a ferromagnetic material is used for the material constituting the rotating cylinder to make it part of the magnetic circuit with magnets applied to heat the magnetocaloric material.

4. An energy conversion element characterized by a plurality of magnetocaloric materials having different temperature regions connected in series so that the temperature of the low temperature state of one magnetocaloricing material is thermally connected to the high temperature state of the other magnetocaloric material on both sides of a disk or cylinder or conical base whose surface is composed of a heat insulating material, within the energy conversion element in which the space between the magnetocaloric material which rotates or reciprocates and the magnetic field application section which includes permanent magnets for applying a magnetic field to the magnetocaloric material are filled with a liquid or a liquid in which fine particles are dispersed or magnetic fluid and in which the output of the heat on the high temperature side is made through the magnetic field application part by thermal conduction of the heat generated by the application of the magnetic field by the permanent magnets.

5. An energy conversion element assembly characterized in that a plurality of energy conversion elements as in one of claims 1-4 are connected in series by directly or thermally connecting the low-temperature portion and the high-temperature portion of a separate unit, respectively, and a heat exchanger is also installed at the stacking joint of the elements, thereby increasing the temperature range of heating and cooling and enabling output in multiple temperature ranges.

6. A multiple temperature control temperature regulator characterized by the use of multiple temperature outputs from an energy conversion element aggregate according to claim 5.
